(19) United States
(12) Patent Application Publication
(10) Pub. No.: US 2025/0226592 A1
(43) Pub. Date: Jul. 10, 2025

(54) ANTENNA APPARATUS AND WIRELESS COMMUNICATION DEVICE

(71) Applicant: HUAWEI TECHNOLOGIES CO., LTD., Shenzhen (CN)

(72) Inventors: Meiqing QI, Shanghai (CN); Peng HUANG, Shanghai (CN); Yinhua YU, Shanghai (CN)

(21) Appl. No.: 19/090,612

(22) Filed: Mar. 26, 2025

Related U.S. Application Data
(63) Continuation of application No. PCT/CN2023/102883, filed on Jun. 27, 2023.

(30) Foreign Application Priority Data
Sep. 27, 2022 (CN) 202211186753.7

(51) Int. Cl. H01Q 21/06; H01Q 9/04; H01Q 19/00; H01Q 21/00

(52) U.S. Cl. CPC H01Q 21/065; H01Q 9/0414; H01Q 19/005; H01Q 21/0006

(57) ABSTRACT

An antenna apparatus includes an antenna array. An antenna element in the antenna array includes a metal ground plane, a first support layer, disposed on a side of the metal ground plane and spaced from the metal ground plane, a radiating patch, disposed on a side surface that is of the first support layer and that is away from the metal ground plane, a feed network, disposed on a side surface that is of the first support layer and that faces the metal ground plane, and spaced from the metal ground plane, and a feed structure disposed on the first support layer. The feed network feeds the radiating patch through a corresponding feed structure. The radiating patch includes a first patch body and a first window. A vertical projection of the feed network onto a plane on which the radiating patch is located at least partially overlaps the first patch body.

### CROSS-REFERENCE TO RELATED APPLICATION(S)

This application is a continuation of International Application No. PCT/CN2023/102883, filed on Jun. 27, 2023, which claims priority to Chinese Patent Application No. 202211186753.7, filed on Sep. 27, 2022. The disclosures of the aforementioned applications are hereby incorporated by reference in their entireties.

### TECHNICAL FIELD

This application relates to the field of antenna technologies, and in particular, to an antenna apparatus and a wireless communication device.

### BACKGROUND

Patch antennas have advantages of a small volume, a light weight, low costs, easy integration with a printed circuit board, and the like, and are widely used in the field of modern mobile communication. With development of 5G massive multiple-input multiple-output (MIMO) antennas, a size of an antenna array is further expanded, and a quantity of channels is continuously increased.

Because a signal needs to be fed into the antenna array, sufficient space needs to be reserved to deploy a complex feed network. Therefore, an available layout area for the feed network is crucial. When a layout area for a feed network of an existing antenna array is small, and an antenna such as a radiating patch and the feed network are arranged close to each other, mutual coupling formed between the radiating patch and the feed network affects antenna performance such as directivity, a gain, a standing wave, and isolation to some extent. This is not conducive to miniaturization of an antenna apparatus.

### SUMMARY

This application provides an antenna apparatus and a wireless communication device. The antenna apparatus can increase a layout area for a feed network, and when a radiating patch and the feed network are arranged close to each other, mutual coupling between the radiating patch and the feed network can be reduced, to reduce impact on antenna performance. This facilitates miniaturization of the antenna apparatus.

According to a first aspect, an antenna apparatus is provided. The antenna apparatus includes at least one antenna array. The antenna array includes at least one antenna element. The antenna element includes: a metal ground plane, configured to perform directional radiation on an electromagnetic wave signal; a first support layer, disposed on a side of the metal ground plane and spaced from the metal ground plane; a radiating patch, disposed on a side surface that is of the first support layer and that is away from the metal ground plane; at least one feed network, disposed on a side surface that is of the first support layer and that faces the metal ground plane, and spaced from the metal ground plane; and at least one feed structure, disposed on the first support layer, where each feed structure corresponds to one feed network, and the feed network feeds the radiating patch through the corresponding feed structure. The radiating patch includes a first patch body and at least one first window. A vertical projection of the feed network onto a plane on which the radiating patch is located at least partially overlaps the first patch body or at least partially overlaps each of the first patch body and the at least one first window. At least one end of the feed network extends out of the radiating patch.

Because the feed network and the radiating patch are spaced and stacked, the feed network may be disposed in both a lower region of the radiating patch and an outer region of the radiating patch (that is, space between adjacent radiating patches), so that a layout area for the feed network can be increased. In addition, at least one end of the feed network extends out of the radiating patch, so that feed networks of adjacent antenna elements can be connected. Further, the radiating patch includes the first patch body and the first window, and the vertical projection of the feed network onto the plane on which the radiating patch is located at least partially overlaps the first patch body or at least partially overlaps each of the first patch body and the first window. In this way, when the feed network and the radiating patch are arranged close to each other, the first window can change an electromagnetic field of the radiating patch at the feed network, to reduce mutual coupling between the radiating patch and the feed network, so that impact on antenna performance is reduced. This facilitates miniaturization of the antenna apparatus.

In a possible implementation, an area of overlap between the vertical projection of the feed network onto the plane on which the radiating patch is located and the at least one first window is greater than an area of overlap between the vertical projection and the first patch body. In other words, in this implementation, to better reduce electromagnetic field strength of the radiating patch at the feed network to reduce impact of mutual coupling between the radiating patch and the feed network on antenna performance, a larger part of the projection of the feed network onto the plane on which the radiating patch is located overlaps the first window.

In a possible implementation, the first patch body includes a first strip-shaped patch and at least one patterned patch, the first strip-shaped patch is bent to form an internal opening, the patterned patch is disposed in one part of a region of the internal opening, and the other part of the region is a window region; or the first patch body includes at least one first strip-shaped patch and at least one patterned patch, and the at least one first strip-shaped patch and the at least one patterned patch are spliced to form a window region. The at least one first window is located in the window region. In other words, in this implementation, to facilitate placement or removal of the radiating patch provided with the first window and the patterned patch, the first strip-shaped patch may be used as an outer frame, and the first strip-shaped patch and the patterned patch may be integrally formed or separately formed, and connected to form a window region. The patterned patch may be, for example, a rectangle.

In a possible implementation, the feed network extends in a first direction, the at least one patterned patch includes a first group of patches and a second group of patches that are spaced from each other in a second direction, the second direction is set at an angle to the first direction, and the first group of patches and the second group of patches are located on two sides of the feed network. In other words, in this implementation, to reduce an area of overlap between the feed network and the first patch body to reduce mutual coupling, patterned patches may be located on two sides of the feed network, or patterned patches may be disposed on only one side of the feed network, so that a larger part of a region of the feed network can overlap the first window, and a smaller part of the region can overlap the first strip-shaped patch.

In a possible implementation, the first patch body further includes at least one second strip-shaped patch, the at least one second strip-shaped patch is disposed in the window region to divide the window region into at least two first windows, different second strip-shaped patches are disposed at an angle to each other, a first end of the second strip-shaped patch is connected to the first strip-shaped patch or the patterned patch, and a second end of the second strip-shaped patch is connected to the first strip-shaped patch or the patterned patch. In other words, in this implementation, a plurality of first windows may be formed by disposing the second strip-shaped patch in the window region, and an area of the first window is relatively small, so that flatness of the radiating patch can be improved, to facilitate placement or removal of the radiating patch.

In a possible implementation, the first patch body includes at least one second strip-shaped patch and at least one patterned patch, different second strip-shaped patches are disposed at an angle to each other, space between adjacent second strip-shaped patches forms a window region, the patterned patch is located in the window region and is connected to the second strip-shaped patch, and a region that is in the window region and in which the patterned patch is not disposed forms the first window. In other words, in this implementation, the radiating patch may have no outer frame, the at least one second strip-shaped patch may be used as an inner frame to form a window region, and the patterned patch may be disposed in the window region. In this case, at least a part of the window region may be divided into a region in which the patterned patch is disposed and a region that forms a first window. Optionally, the patterned patch may not be disposed in some window regions, and in this case, the window region forms a first window.

In a possible implementation, a shape of the at least one first window includes a regular shape and/or an irregular shape, and the regular shape includes a polygon or a circle; and a shape of the at least one patterned patch of the first patch body includes a regular shape and/or an irregular shape. For example, the shape of the patterned patch may be an L shape or an H shape, or may be another shape. In other words, in this implementation, the shape of the first window and the shape of the patterned patch may be set according to a requirement.

In a possible implementation, the feed structure includes a first feed part, the first feed part is disposed on the side surface that is of the first support layer and that faces the metal ground plane, the feed network is capable of feeding one end of the first feed part, and the other end of the first feed part corresponds to the first patch body and is capable of feeding the first patch body through coupling. In other words, in this implementation, the first feed part and the feed network are disposed at a same layer, and after the feed network feeds the first feed part, the first feed part feeds the radiating patch through coupling.

In a possible implementation, the feed structure includes a second feed part, the second feed part is disposed in the first support layer, the feed network is capable of feeding one end of the second feed part, and the other end of the second feed part is capable of feeding the radiating patch. The one end of the second feed part is directly connected to the feed network; or the one end of the second feed part and the feed network are spaced from each other in a thickness direction of the first support layer or spaced from each other on a plane on which the feed network is located, and the feed network is capable of feeding the one end of the second feed part through coupling. In other words, in this implementation, the second feed part may be embedded in the first support layer, and the feed network is located on the side surface that is of the first support layer and that faces the metal ground plane. In this case, the feed network may feed the second feed part directly or through coupling, and then the second feed part may feed the radiating patch.

In a possible implementation, the feed structure includes: a first feed part, disposed on the side surface that is of the first support layer and that faces the metal ground plane, where the feed network is capable of feeding one end of the first feed part; and a second feed part, disposed in the first support layer, where the other end of the first feed part is capable of feeding one end of the second feed part, and the other end of the second feed part is capable of feeding the radiating patch. The one end of the second feed part is directly connected to the other end of the first feed part; or the one end of the second feed part and the first feed part are spaced from each other in a thickness direction of the first support layer or spaced from each other on a plane on which the first feed part is located, and the other end of the first feed part is capable of feeding the one end of the second feed part through coupling. In other words, in this implementation, after the feed network feeds the first feed part, the first feed part may feed the second feed part directly or through coupling.

In a possible implementation, the one end of the first feed part is directly connected to the feed network; or the one end of the first feed part is spaced from the feed network, and the feed network is capable of feeding the one end of the first feed part through coupling. In other words, in this implementation, the feed network may feed the first feed part directly or through coupling.

In a possible implementation, the other end of the second feed part is directly connected to the first patch body; or the other end of the second feed part and the first patch body are spaced from each other in the thickness direction of the first support layer or spaced from each other on the plane on which the radiating patch is located, and the other end of the second feed part is capable of feeding the first patch body through coupling. In other words, in this implementation, the second feed part may feed the radiating patch, for example, the first patch body, directly or through coupling.

In a possible implementation, the second feed part of the feed structure includes a main feed portion. When the one end of the second feed part receives feed from the feed network through coupling, the second feed part further includes a first coupling portion, the first coupling portion is connected to one end of the main feed portion, the first coupling portion and the feed network are spaced from each other in the thickness direction of the first support layer or spaced from each other on the plane on which the feed network is located, and an area of a vertical projection of the first coupling portion onto the plane on which the feed network is located is greater than an area of a vertical projection of the one end of the main feed portion onto the plane on which the feed network is located; and/or when the other end of the second feed part feeds the radiating patch through coupling, the second feed part further includes a second coupling portion, the second coupling portion is connected to the other end of the main feed portion, the second coupling portion and the radiating patch are spaced from each other in the thickness direction of the first support layer or spaced from each other on the plane on which the radiating patch is located, and an area of a vertical projection of the second coupling portion onto the plane on which the radiating patch is located is greater than an area of a vertical projection of the other end of the main feed portion onto the plane on which the radiating patch is located. In other words, in this implementation, when the second feed part receives feed from the feed network through coupling, if an area of a vertical projection, onto the plane on which the feed network is located, of an end part that is of the main feed portion of the second feed part and that faces the feed network is large enough to meet a coupling feed requirement, the main feed portion may feed the radiating patch through coupling. Alternatively, a first coupling portion may be disposed at one end that is of the main feed portion and that faces the feed network, to receive feed from the feed network by using the first coupling portion. Similarly, when the second feed part feeds the radiating patch through coupling, if an area of a vertical projection, onto the plane on which the radiating patch is located, of an end part for feeding that is of the main feed portion of the second feed part and that faces the radiating patch is large enough to meet a coupling feed requirement, the main feed portion may feed the radiating patch through coupling. Alternatively, a second coupling portion may be disposed at the other end that is of the main feed portion and that faces the radiating patch, to feed the radiating patch by using the second coupling portion.

In a possible implementation, the antenna element is a dual-polarized antenna, an outer contour of the radiating patch is a rectangle, the at least one feed structure includes a first feed structure and a second feed structure, the first feed structure and the second feed structure are located at two adjacent vertex angles or two adjacent sides of the radiating patch respectively, the first feed structure is configured to feed an electromagnetic wave in a first polarization direction into the radiating patch, the second feed structure is configured to feed an electromagnetic wave in a second polarization direction into the radiating patch, the first polarization direction is orthogonal to the second polarization direction, and the at least one feed network is located between the first feed structure and the second feed structure. In other words, in this implementation, the antenna apparatus may be a dual-polarized antenna, and a shape of the radiating patch may be a rectangle. Certainly, the shape of the radiating patch may alternatively be a circle or another polygon.

In a possible implementation, the antenna element further includes one parasitic radiating component or at least two parasitic radiating components that are stacked, and the parasitic radiating component includes: a second support layer, disposed on a side surface that is of the radiating patch and that is away from the first support layer; and one or at least two parasitic radiating patches, disposed on a side surface that is of the second support layer and that is away from the radiating patch, and at least partially overlapping the radiating patch. In other words, in this implementation, to expand bandwidth, a parasitic radiating patch may be disposed according to a requirement, and in each antenna element, each layer of parasitic radiating patch may include one or at least two parasitic radiating patches.

In a possible implementation, the parasitic radiating patch includes at least one second window and a second patch body, and a vertical projection of the feed network onto a plane on which the parasitic radiating patch is located partially or completely overlaps at least one of the second window and the second patch body. A shape of the second window is the same as or different from a shape of the first window, and a structure of the second patch body is the same as or different from a structure of the first patch body. In other words, in this implementation, to reduce electromagnetic field strength of the parasitic radiating patch at the feed network, a second window may be provided on the parasitic radiating patch, and a structure of the parasitic radiating patch may be the same as or different from (including similar to) a structure of the radiating patch.

In a possible implementation, a material of the second support layer is the same as or different from a material of the first support layer. In other words, in this implementation, the material of the second support layer may be selected according to a requirement, and the material of the second support layer may be the same as or different from the material of the first support layer.

In a possible implementation, the material of the first support layer includes one of the following: ceramic, plastic, or foam. In other words, in this implementation, to implement a support function, the material of the first support layer may be one of the following: ceramic, plastic, or foam. Certainly, the first support layer may alternatively be made of another suitable material. In addition, if necessary, the first support layer may alternatively be a combination of a plurality of materials.

In a possible implementation, the antenna array includes a plurality of antenna elements. The plurality of antenna elements are arranged in an array according to a specified shape, and feed networks of the plurality of antenna elements are connected; or the plurality of antenna elements are divided into a plurality of groups, and feed networks of each group of antenna elements are connected. Metal ground planes of the plurality of antenna elements are integrally formed or separately formed; first support layers of the plurality of antenna elements are integrally formed or separately formed; and second support layers of the plurality of antenna elements are integrally formed or separately formed. In other words, in this implementation, the plurality of antenna elements may be spliced to form the antenna array, or the metal ground planes, the first support layers, and the second support layers of the plurality of antenna elements may be integrally formed, and radiating patches of the plurality of antenna elements are spaced from each other; the feed network (that is, a part that is of the feed network and that extends out of the radiating patch) is disposed in space between adjacent radiating patches; and parasitic radiating patches of the plurality of antenna elements may also be spaced from each other.

According to a second aspect, a wireless communication device is provided. The wireless communication device includes at least one antenna apparatus provided in the first aspect and at least one first radio frequency circuit. At least a part of feed networks of a same antenna apparatus is connected to a same radio frequency circuit, or different feed networks of a same antenna apparatus are connected to different radio frequency circuits.

Other features and advantages of the present technology are described in detail in subsequent specific embodiments.

### BRIEF DESCRIPTION OF DRAWINGS

The following briefly describes accompanying drawings used in descriptions of embodiments or a conventional technology.

FIG. 1A is a diagram of an example application scenario of an antenna apparatus;

FIG. 1B is a diagram of an example of a structure of an antenna array of the antenna apparatus in FIG. 1A;

FIG. 2A is a diagram of an assembly structure of an antenna element of an antenna apparatus according to an example embodiment of this application;

FIG. 2B is a diagram of an example of an exploded structure of the antenna element shown in FIG. 2A;

FIG. 2C is a diagram of an example of a cross-sectional structure of the antenna element shown in FIG. 2A along an A-A line;

FIG. 2D is a diagram of a partial structure of the example antenna element of the antenna apparatus shown in FIG. 2A;

FIG. 3A is a diagram of an assembly structure of an antenna element of an antenna apparatus according to an example embodiment of this application;

FIG. 3B is a diagram of an example structure of a radiating patch of the antenna element shown in FIG. 3A;

FIG. 3C is a diagram of an example of an exploded structure of the antenna element shown in FIG. 3A;

FIG. 3D is a diagram of an example of a cross-sectional structure of the antenna element shown in FIG. 3A along a B-B line;

FIG. 4A is a diagram of an assembly structure of an antenna element of an antenna apparatus according to an example embodiment of this application;

FIG. 4B is a diagram of an example structure of a radiating patch of the antenna element shown in FIG. 4A;

FIG. 4C is a diagram of an example of an exploded structure of the antenna element shown in FIG. 4A; and

FIG. 4D is a diagram of an example of a cross-sectional structure of the antenna element shown in FIG. 4A along a C-C line.

### DESCRIPTION OF EMBODIMENTS

In descriptions of this application, orientations or location relationships indicated by the terms “center”, “upper”, “lower”, “front”, “rear”, “left”, “right”, “vertical”, “horizontal”, “top”, “bottom”, “inner”, “outer”, and the like are based on orientations or location relationships shown in the accompanying drawings, and are merely intended for ease of describing this application and simplifying descriptions, instead of indicating or implying that a specified apparatus or element needs to have a specific orientation, and be constructed and operated in the specific orientation. Therefore, this cannot be understood as a limitation on this application.

In the descriptions of this application, unless otherwise specified and limited, the terms “installation”, “link”, and “connection” should be understood in a broad sense. For example, the term “connection” may be a fixed connection, a detachable connection, a contact connection, or an integrated connection. A person of ordinary skill in the art may understand specific meanings of the terms in this application according to specific situations.

The following describes in detail acronyms and key terms used in embodiments of this application.

MIMO (multiple-input multiple-output) can mean a multiple-input multiple-output technology in which a plurality of transmit antennas and a plurality of receive antennas are used at a transmit end and a receive end respectively, so that signals are transmitted and received by using the plurality of antennas at the transmit end and the receive end, to improve communication quality. MIMO can make full use of space resources and implement multiple transmission and multiple reception by using a plurality of antennas, and can multiply a system channel capacity without increasing spectrum resources and antenna transmit power, demonstrating significant advantages.

MM/Massive MIMO (massive multiple-input multiple-output) is an antenna technology for wireless communication. In this technology, massive multiple antennas are used at both a source (a transmitter) and a destination (a receiver). In addition, antennas at each end of a communication loop are combined to achieve a minimum bit error rate and an optimal data transmission rate.

A dual-polarized antenna is an antenna that combines two orthogonal polarization directions of +45°/−45° (or 0°/90°), and works in a dual-working mode for transmission and reception. Therefore, a most prominent advantage of the dual-polarized antenna is to reduce a quantity of antennas of a single directional base station. To be specific, the orthogonal dual-polarized antenna has functions of two single-polarized antennas, and can transmit (or receive), through two feed ports respectively, two electromagnetic waves whose main polarization directions are orthogonal to each other, so that space can be saved and costs can be reduced.

Antenna isolation, for a signal transmitted by an antenna, means a ratio of a signal received by another antenna to the transmitted signal. The antenna isolation depends on an antenna radiation pattern, a spatial distance between antennas, and an antenna gain. Isolation is an interference suppression measure taken to minimize impact of various types of interference on a receiver. Port isolation means a degree of mutual interference between feed ports. For a signal that is input on a port, greater port isolation indicates a weaker output signal on another port.

An S parameter is a network parameter based on a relationship between an incident wave and a reflected wave, is applicable to microwave circuit analysis, and describes a circuit network by using a reflected signal on a device port and a signal transmitted from the port to another port. For four S parameters of a two-port network, Sij indicates energy measured at a port i when energy is injected from a port j. For example, S11 is defined as a square root of a ratio of energy reflected from a port 1 to input energy, and is often simplified as a ratio of an equivalent reflected voltage to an equivalent incident voltage. A physical meaning of each parameter and a characteristic of a special network are as follows: S11 indicates a reflection coefficient (an input return loss) of a port 1 when a port 2 is matched, S22 indicates a reflection coefficient (an output return loss) of the port 2 when the port 1 is matched, S12 indicates a reverse transmission coefficient from the port 2 to the port 1 when the port 1 is matched, and S21 indicates a forward transmission coefficient from the port 1 to the port 2 when the port 2 is matched. S11 and S22 are port reflection coefficients. S12 and S21 are port isolation. “Matched port” indicates that there is no reflection on the port, with zero reflected wave.

It should be noted that embodiments of this application and features in embodiments may be mutually combined in the case of no conflict. This application is described below in detail with reference to the accompanying drawings by using embodiments.

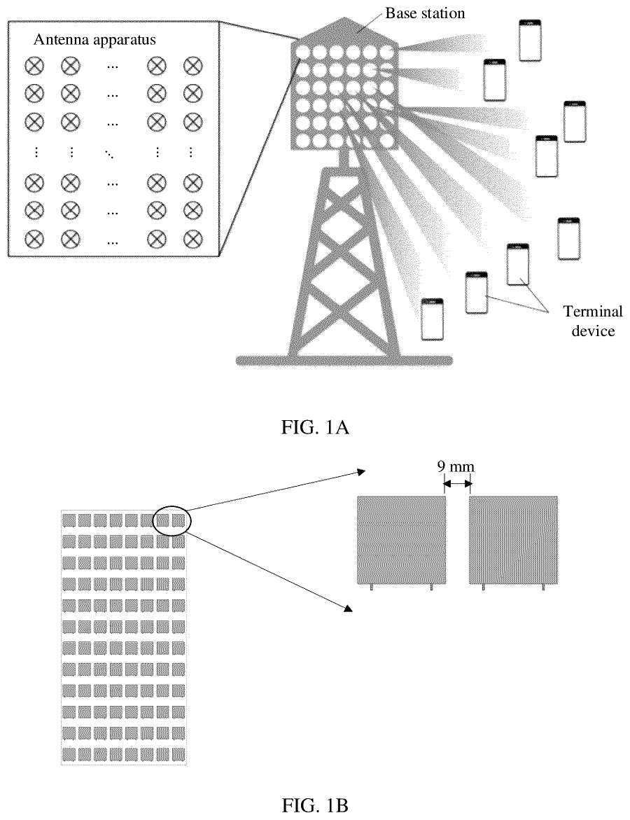

FIG. 1A is a diagram of an application scenario of an antenna apparatus. As shown in FIG. 1A, an antenna apparatus is disposed on a base station, and the base station separately communicates with a plurality of terminal devices such as mobile phones by using the antenna apparatus. The antenna apparatus may include at least one antenna array. The antenna array may include a plurality of antenna elements. The antenna element may be a patch antenna. In addition, the antenna apparatus may also be disposed in another wireless communication device, for example, used in a terminal device such as a mobile phone or a tablet if necessary.

With large-scale development of massive MIMO, a size of a corresponding antenna array is further expanded. Because a signal needs to be fed into a large-scale antenna array, sufficient space needs to be reserved to deploy a complex feed network. In other words, an available layout area for the feed network is crucial. In addition, when a radiating patch and the feed network of the antenna array are arranged close to each other, mutual coupling affects antenna performance such as directivity, a gain, a standing wave, and isolation to some extent. Therefore, how to implement miniaturization of an antenna apparatus and increase a layout area for a feed network in limited space becomes an issue to be urgently resolved.

A feed network and a radiating patch in an antenna element may be disposed at a same layer, and the feed network may be disposed on an outer side of the radiating patch. Because an outer region of the radiating patch is small, and the radiating patch uses a side feeding manner, a feed structure occupies a part of the outer region, and consequently a layout area for the feed network is small. After an array scale is increased, the feed network may be more complex, and the layout area cannot meet a requirement. The following provides specific descriptions with reference to FIG. 1B.

FIG. 1B is a diagram of an example of a structure of an antenna array of the antenna apparatus in FIG. 1A. As shown in FIG. 1B, a size of a patch antenna is in direct proportion to a wavelength corresponding to an operating frequency of the patch antenna, and the patch antenna usually operates at a half wavelength and has a large size. In FIG. 1B, when the size of the patch antenna is the half wavelength, a gap between two adjacent radiating patches is small, for example, only 9 mm. A complex feed network cannot be deployed in the gap.

In addition, when the two adjacent radiating patches are excessively close to each other, co-polarization (between a plurality of radiating patches located in a same column) isolation and hetero-polarization (between a plurality of radiating patches located in different columns) isolation in columns become poor, and antenna performance cannot be ensured.

Alternatively, a feed network and a radiating patch may be stacked (that is, disposed at different layers), a metal ground plane is located between the feed network and the radiating patch, an open slot is provided on the metal ground plane, and the feed network feeds the radiating patch through coupling by using the open slot. This causes a complex stacked structure and a high profile, and is not conducive to miniaturization.

In view of this, embodiments of this application provide an antenna apparatus and a wireless communication device. The antenna apparatus is mainly used in a scenario of base station communication, and is applicable to an electromagnetic wave of any frequency band and any polarized antenna, for example, is applicable to a dual-polarized array antenna apparatus of a base station, and may be specifically a 5G MM base station antenna module. Compared with an existing solution in which a feed network is routed beside an antenna array element/a radiating patch, the antenna apparatus can increase a layout area for a feed network, and when a distance between the feed network and a radiating patch is small, that is, the feed network and the radiating patch are arranged close to each other, an electromagnetic field of the radiating patch at the feed network can be changed, to reduce mutual coupling between an array antenna and the feed network, to avoid or reduce impact on directivity, a gain, a standing wave, and isolation of an antenna. This facilitates miniaturization of the antenna apparatus. In other words, a design of an antenna element can reduce mutual coupling/coupling effect between the array antenna and the feed network in a low-profile and simple-stacking condition, and reduce impact on antenna performance, for example, can improve isolation, array directivity, a gain, and the like.

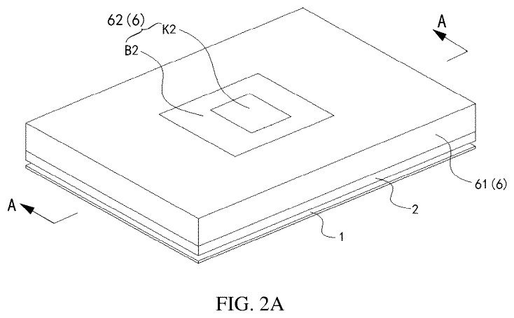

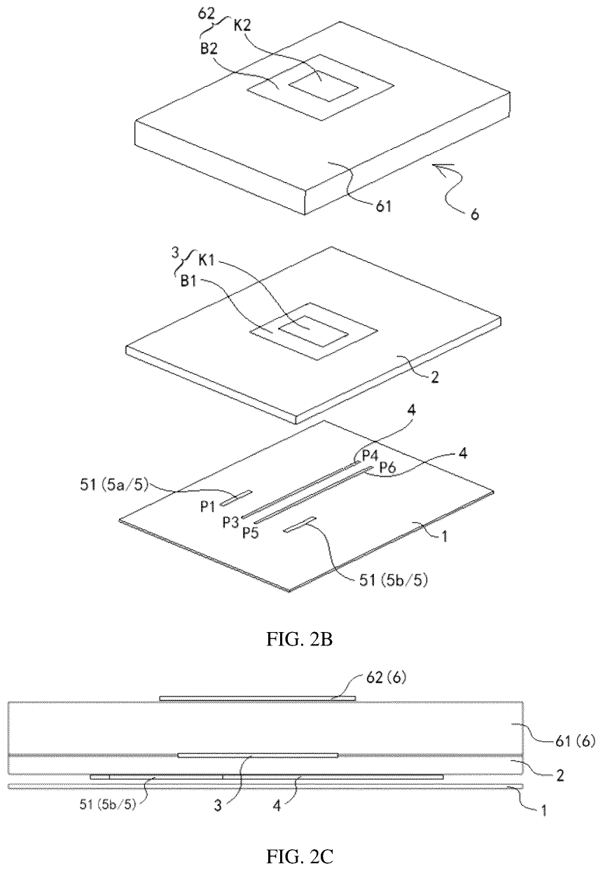

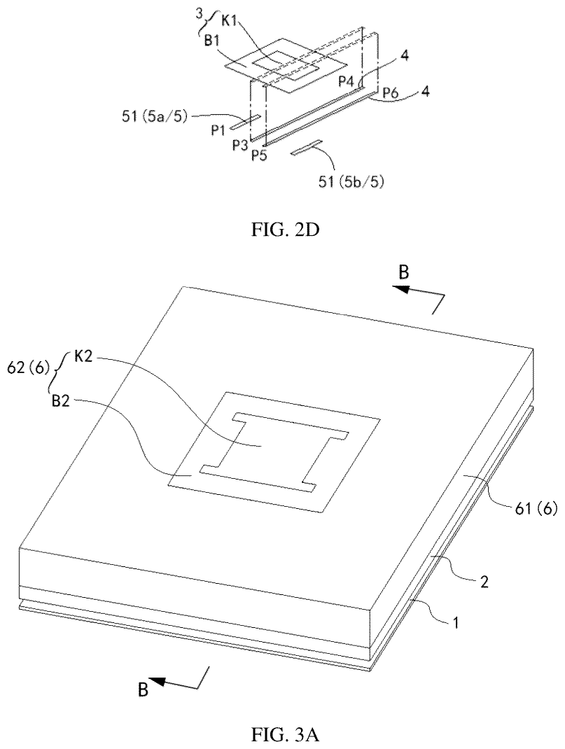

FIG. 2A is a diagram of an assembly structure of an antenna element of an antenna apparatus according to Embodiment 1 of this application. FIG. 2B is a diagram of an example of an exploded structure of the antenna element shown in FIG. 2A. As shown in FIG. 2A and FIG. 2B, an antenna array may include at least one antenna element. The antenna element may include a metal ground plane 1, a first support layer 2, a radiating patch 3, at least one feed network 4, and at least one feed structure 5. The metal ground plane 1 is configured to perform directional radiation on an electromagnetic wave signal. The first support layer 2 is disposed on a side of the metal ground plane 1 and spaced from the metal ground plane 1. To implement a good support function, a material of the first support layer 2 may include one of the following: ceramic, plastic, or foam. Certainly, the first support layer 2 may alternatively be made of another suitable material. In addition, if necessary, the first support layer 2 may alternatively be a combination of a plurality of materials.

The feed network 4 is a line that transmits, to an antenna radiator such as the radiating patch 3, an electrical signal sent by a device such as a radio frequency circuit. The feed network 4 may be, for example, a microstrip or a coaxial cable. The radiating patch 3, the feed structure 5, and a parasitic radiating patch 62 described below may be metal sheets. In addition, materials of the radiating patch 3, the feed structure 5, and the radiating patch 62 may be the same or different. The materials of the radiating patch 3, the feed structure 5, and the radiating patch 62 may be, for example, copper, silver, gold, aluminum, or other metal.

An outer contour of the radiating patch 3 may be a circle or a polygon, and the polygon may be, for example, a rectangle. In addition, the antenna element may be a single-polarized antenna or a dual-polarized antenna. Optionally, the antenna element may be a more polarized antenna, for example, a triple-polarized antenna.

As shown in FIG. 2B, the antenna element may be a dual-polarized antenna, the outer contour of the radiating patch 3 may be a rectangle, and the at least one feed structure 5 includes a first feed structure 5a and a second feed structure 5b. The first feed structure 5a and the second feed structure 5b are located at two adjacent vertex angles of the radiating patch 3 respectively, or may be located at two adjacent sides of the radiating patch 3 respectively. The first feed structure 5a is configured to feed an electromagnetic wave in a first polarization direction into the radiating patch 3, the second feed structure 5b is configured to feed an electromagnetic wave in a second polarization direction into the radiating patch 3, and the first polarization direction is orthogonal to the second polarization direction. The at least one feed network 4 is located between the first feed structure 5a and the second feed structure 5b. To be specific, the feed network 4 may run through two opposite sides of the radiating patch 3, and one or at least two feed networks 4 may be disposed between the first feed structure 5a and the second feed structure 5b. In other words, the first feed structure 5a is located on one side of the one or at least two feed networks 4, and the second feed structure 5b is located on the other side of the one or at least two feed networks 4.

FIG. 2C is a diagram of an example of a cross-sectional structure of the antenna element shown in FIG. 2A along an A-A line. As shown in FIG. 2C, the radiating patch 3 may be disposed on a side surface that is of the first support layer 2 and that is away from the metal ground plane 1, and the radiating patch 3 is configured to transmit/receive an electromagnetic wave signal. The at least one feed network 4 is disposed on a side surface that is of the first support layer 2 and that faces the metal ground plane 1, and is spaced from the metal ground plane 1. The at least one feed structure 5 is disposed on the first support layer 2. For example, the feed structure 5, such as a first feed part 51 described below, is disposed on a side wall that is of the first support layer 2 and that faces the metal ground plane 1, that is, at a same layer as the feed network 4. Alternatively, the feed structure 5, such as a second feed part 52 described below, is located in the first support layer 2. Specifically, the second feed part 52 may be embedded in the first support layer 2 when the first support layer 2 is manufactured. Each feed structure 5 corresponds to one feed network 4, and the feed network 4 feeds the radiating patch 3 through the corresponding feed structure 5. In other words, the feed structure 5 is located between the radiating patch 3 and the feed network 4 in a direction of a propagation path of an electromagnetic wave signal.

Further, to expand bandwidth, as shown in FIG. 2A, FIG. 2B, and FIG. 2C, the antenna element may further include one parasitic radiating component 6 or at least two parasitic radiating components 6 that are stacked. The parasitic radiating component 6 may include a second support layer 61 and one or at least two parasitic radiating patches 62. The second support layer 61 is disposed on a side surface that is of the radiating patch 3 and that is away from the first support layer 2. In addition, a material of the second support layer 61 may be selected according to a requirement, and the material of the second support layer 61 may be the same as or different from the material of the first support layer 2. In addition, at least one of the first support layer 2 and the second support layer 61 may be replaced with air. The one or at least two parasitic radiating patches 62 are disposed on a side surface that is of the second support layer 61 and that is away from the radiating patch 3, and at least partially overlap the radiating patch 3. To be specific, one or at least two layers of parasitic radiating patches 62 may be disposed according to a requirement, and each layer of parasitic radiating patch 62 may include one or at least two parasitic radiating patches 62.

To reduce electromagnetic field strength of the parasitic radiating patch 62 at the feed network, a second window K2 may be provided on the parasitic radiating patch 62. To be specific, the parasitic radiating patch 62 may include at least one second window K2 and a second patch body B2, and a vertical projection of the feed network 4 onto a plane on which the parasitic radiating patch 62 is located partially or completely overlaps at least one of the second window K2 and the second patch body B2. In addition, a shape of the second window K2 may be the same as or different from a shape of a first window K1. A structure of the second patch body B2 may be the same as or different from a structure of a first patch body B1. In FIG. 2A and FIG. 2B, both the shape of the first window K1 and the shape of the second window K2 are rectangles, and the structure of the second patch body B2 is similar to the structure of the first patch body B1. In other words, a structure of the parasitic radiating patch 62 may be the same as or different from (including similar to) a structure of the radiating patch 3. In this embodiment of this application, an example in which the structure of the parasitic radiating patch 62 is similar to the structure of the radiating patch 3 is mainly used for description.

Still refer to FIG. 2B. The feed structure 5 may include a first feed part 51, and the first feed part 51 is disposed on the side surface that is of the first support layer 2 and that faces the metal ground plane 1. The feed network 4 can feed one end of the first feed part 51. Specifically, the one end of the first feed part 51 may be spaced from the feed network 4, and the feed network 4 can feed the one end of the first feed part 51 through coupling; or the one end of the first feed part 51 may be directly connected to the feed network 4, that is, directly fed by the feed network 4. As shown in FIG. 2C, the other end of the first feed part 51 corresponds to the first patch body B1, and can feed the first patch body B1 through coupling. In other words, the first feed part 51 and the feed network 4 are disposed at a same layer, and after the feed network 4 feeds the first feed part 51, the first feed part 51 feeds the radiating patch 3 through coupling.

As shown in FIG. 2B, an end that is of the first feed structure 5a and that receives feed from the feed network 4 (including direct feed under a direct connection or coupling feed under a spaced arrangement) is P1, and an end that is of the second feed structure 5b and that receives feed from the feed network 4 (including direct feed under a direct connection or coupling feed under a spaced arrangement) is P2. The two feed points P1 and P2 are located at two adjacent sides or two adjacent angles of the radiating patch 3 respectively, and are two input ports of the radiating patch 3, so that ±45° dual-polarization can be implemented.

The feed network 4 is located between the radiating patch 3 and the metal ground plane 1. A part of feeder lines of the feed network 4 is located below the radiating patch 3, runs through two opposite radiation sides of the radiating patch 3, and is located between the two feed points, that is, P1 and P2. In addition, the parasitic radiating patch 62 is added on the radiating patch 3, to expand bandwidth. Further, each of the radiating patch 3 and the parasitic radiating patch 62 may use one or more windows/open slots (including but not limited to a square, a rectangle, an arc, or the like), to greatly reduce coupling to the feed network 4. This facilitates antenna miniaturization.

One or more feed networks 4 may be disposed between the two feed points P1 and P2. In FIG. 2B, two feed networks 4 are disposed between the two feed points P1 and P2. P4 and P6 are input ports of the two feed networks 4 respectively, and P3 and P5 are output ports of the two feed networks 4 respectively. Because port isolation between the radiating patch 3 and the feed network 4 is inconvenient to measure, and the feed structure 5 is connected to the radiating patch 3 (that is, directly or through coupling), it is sufficient to measure port isolation between the feed structure 5 and the feed network 4. The following uses port isolation between the feed point P1 and the respective input ports and output ports of the two feed networks 4 as an example for description. In this case, the feed network 4 and the feed point P1 are spaced from and not coupled to each other. For example, during measurement, a section of at least one of the feed network 4 and the feed structure 5 that are directly connected or connected through coupling may be removed, to disconnect the feed network 4 and the feed structure 5.

In an example, port isolation S(3,1), S(4,1), S(5,1), and S(6,1) all can be at least 20 decibels (dB). However, for an antenna element in which a feed network is routed below a radiating patch and a first window is not designed, mutual coupling between the radiating patch and the feed network is high, and isolation is poor and usually greater than −15 dB. It can be learned that an array antenna and the feed network in this embodiment of this application have good isolation improvement effect. After the structure of the antenna element provided in the present technology is used, mutual coupling between the feed structure/radiating patch and the feed network is greatly reduced, and there is larger layout space for the feed network. In this way, after a large-scale array is formed, the structure can obtain a better antenna directivity coefficient and gain.

In addition, the antenna array may include a plurality of antenna elements. The plurality of antenna elements may be arranged in an array according to a specified shape, the plurality of antenna elements may be one group, and feed networks 4 of the plurality of antenna elements are connected. Specifically, each antenna element may include one or at least two feed networks 4, and the one or at least two feed networks 4 of different antenna elements, such as two adjacent antenna elements, may be connected in a one-to-one correspondence. Alternatively, the plurality of antenna elements may be divided into a plurality of groups, and feed networks 4 of each group of antenna elements are connected. Specifically, in a same group, each antenna element may include one or at least two feed networks 4, and the one or at least two feed networks 4 of different antenna elements, such as two adjacent antenna elements, may be connected in a one-to-one correspondence.

In addition, feed networks 4 that are correspondingly connected in different antenna elements include a polarization feed port connected to an external circuit such as a radio frequency circuit, and the external circuit may perform feeding through the polarization feed port.

Metal ground planes 1 of the plurality of antenna elements are integrally formed or separately formed; first support layers 2 of the plurality of antenna elements are integrally formed or separately formed; and second support layers 61 of the plurality of antenna elements are integrally formed or separately formed. To be specific, the plurality of antenna elements may be spliced to form the antenna array, or the metal ground planes 1, the first support layers 2, and the second support layers 61 of the plurality of antenna elements may be integrally formed, and radiating patches 3 of the plurality of antenna elements are spaced from each other; the feed network 4, that is, a part that is of the feed network 4 and that extends out of the radiating patch 3 is disposed in space between adjacent radiating patches 3; and parasitic radiating patches 62 of the plurality of antenna elements may also be spaced from each other.

FIG. 2D is a diagram of a partial structure of the antenna element of the antenna apparatus shown in FIG. 2A. Specifically, FIG. 2D shows the radiating patch 3, the feed network 4, and the feed structure 5 (that is, the first feed part 51), and further shows a vertical projection of the feed network 4 onto a plane on which the radiating patch 3 is located, that is, a structure shown by a dashed line. As shown in FIG. 2B and FIG. 2D, the radiating patch 3 may include a first patch body B1 and at least one first window K1, and the first window K1 may be provided to reduce electromagnetic field coupling between the radiating patch 3 and the feed network 4. As shown in FIG. 2D, the vertical projection of the feed network 4 onto the plane on which the radiating patch 3 is located may at least partially overlap each of the first patch body B1 and the at least one first window K1, and at least one end of the feed network extends out of the radiating patch 3. To be specific, each feed network 4 includes a first part and a second part connected to the first part, the first part is disposed corresponding to the radiating patch 3, and the second part is located on an outer side of the radiating patch 3, so that feed networks 4 of adjacent antenna elements can be connected. Optionally, the vertical projection of the feed network 4 onto the plane on which the radiating patch 3 is located may at least partially overlap only the first patch body B1. In other words, the vertical projection of the feed network 4 onto the plane on which the radiating patch 3 is located may not overlap the first window K1. In other words, because the first window K1 is provided on the radiating patch 3, when the feed network 4 is disposed not corresponding to the first window K1 but corresponding to the first patch body B1, electromagnetic field strength of the radiating patch 3 at the feed network 4 may still be reduced, thereby reducing mutual coupling between the radiating patch 3 and the feed network 4.

In addition, a shape of the at least one first window K1 includes a regular shape and/or an irregular shape, and the regular shape includes a polygon or a circle; and a shape of at least one patterned patch B12 of the first patch body B1 includes a regular shape and/or an irregular shape. In other words, the shape of the first window K1 and the shape of the patterned patch B12 may be set according to a requirement. For example, the shape of the first window K1 may be a rectangle, and the shape of the patterned patch B12 may be an L shape or an H shape, or may be another shape.

Because the feed network 4 and the radiating patch 3 are spaced and stacked, the feed network 4 may be disposed in both a lower region of the radiating patch 3 and an outer region of the radiating patch 3, so that a layout area for the feed network 4 can be increased. In addition, at least one end of the feed network 4 extends out of the radiating patch 3, so that feed networks 4 of adjacent antenna elements can be connected. Further, the radiating patch 3 includes the first patch body B1 and the first window K1, and the vertical projection of the feed network 4 onto the plane on which the radiating patch 3 is located at least partially overlaps the first patch body B1 or at least partially overlaps each of the first patch body B1 and the first window K1. In this way, when the feed network 4 and the radiating patch 3 are arranged close to each other, the first window K1 can change an electromagnetic field of the radiating patch 3 at the feed network 4, to reduce mutual coupling, so that impact on antenna performance is reduced. This facilitates miniaturization.

To better reduce electromagnetic field strength of the radiating patch 3 at the feed network 4 to reduce impact of mutual coupling between the radiating patch 3 and the feed network 4 on antenna performance, an area of overlap between the vertical projection of the feed network 4 onto the plane on which the radiating patch 3 is located and the at least one first window K1 may be greater than an area of overlap between the vertical projection and the first patch body B1. In other words, a larger part of the vertical projection of the feed network 4 onto the plane on which the radiating patch 3 is located overlaps the first window K1.

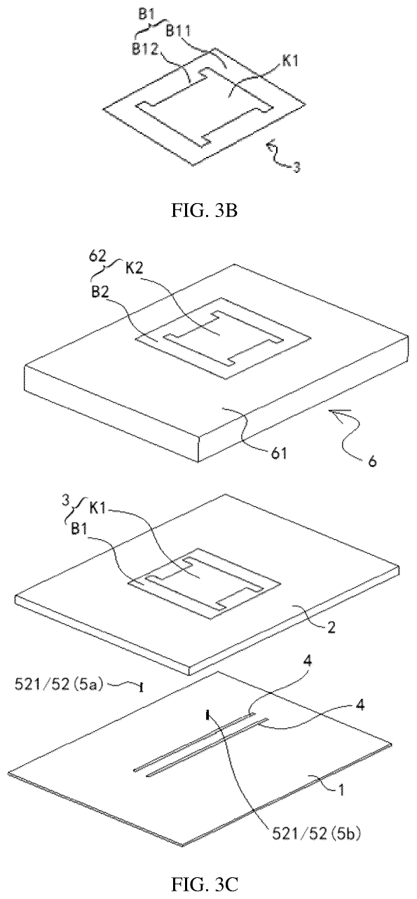

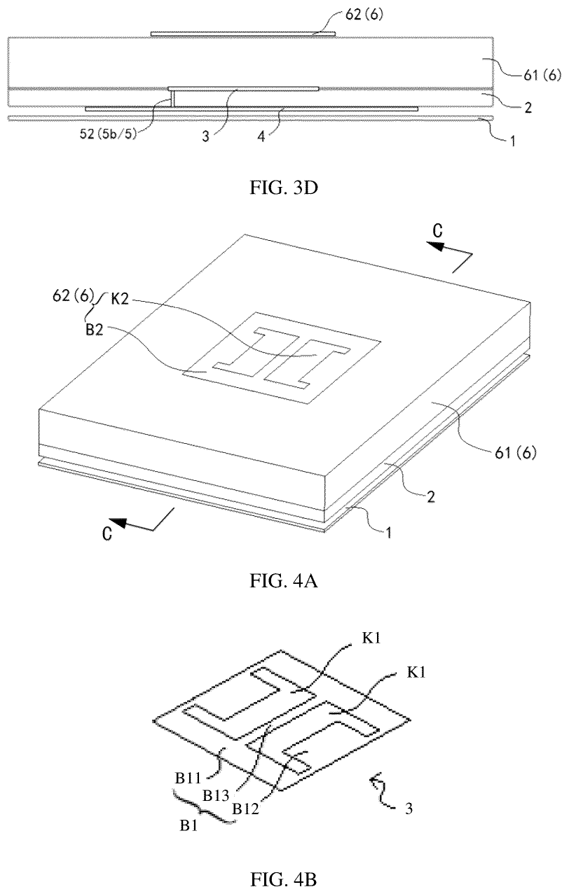

FIG. 3A is a diagram of an assembly structure of an antenna element of an antenna apparatus according to Embodiment 2 of this application. The structure of the antenna element in FIG. 3A is roughly the same as the structure of the antenna element shown in FIG. 2A. A difference from the antenna element shown in FIG. 2A lies in that, in FIG. 3A, a shape of a radiating patch 3 and a shape of a parasitic radiating patch 62 are changed, and a structure of a feed structure 5 is changed. For example, a shape of a second window K2 of the parasitic radiating patch 62 is an irregular shape similar to an “I” shape. The following provides detailed descriptions with reference to FIG. 3B, FIG. 3C, and FIG. 3D.

FIG. 3B is a diagram of a structure of a radiating patch of the antenna element shown in FIG. 3A. As shown in FIG. 3B, a first patch body B1 may include a first strip-shaped patch B11 and at least one patterned patch B12. The first strip-shaped patch B11 and the patterned patch B12 may be integrally formed, or may be separately formed if necessary.

In an example, the first strip-shaped patch B11 is bent to form an internal opening. In other words, the first strip-shaped patch B11 may be used as an outer frame. One integrally-formed first strip-shaped patch B11 may be bent to form an internal opening, or a plurality of first strip-shaped patches B11 may be separately formed and spliced to form an internal opening. The patterned patch B12 is disposed in one part of a region of the internal opening, the other part of the region is a window region, and at least one first window K1 is located in the window region. In FIG. 3B, it may be considered that the first strip-shaped patch B11 is a closed rectangular frame, the patterned patch B12 is a rectangular body, the patterned patch B12 is located in the internal opening of the closed rectangular frame, and a region that is of the internal opening of the closed rectangular frame and in which the patterned patch B12 is not disposed forms the window region.

In another example, the first patch body B1 includes at least one first strip-shaped patch B11 and at least one patterned patch B12, and the at least one first strip-shaped patch B11 and the at least one patterned patch B12 are spliced to form a window region. In FIG. 3B, it may be considered that the first patch body B1 includes two first strip-shaped patches B11 and two patterned patches B12. Two ends of a part that is of a first patterned patch B12 and that is away from the window region extend out of a part that is close to the window region, and are connected to first ends of the two first strip-shaped patches B11 respectively, and two ends of a part that is of a second patterned patch B12 and that is away from the window region extend out of a part that is close to the window region, and are connected to second ends of the two first strip-shaped patches B11 respectively, to form a closed opening, that is, the window region. The window region is a first window K1.

In addition, to reduce an area of overlap between a feed network 4 and the first patch body B1 to reduce mutual coupling, patterned patches B12 may be located on one side or two sides of the feed network 4, so that a larger part of a region of the feed network 4 can overlap the first window K1, and a smaller part of the region can overlap the first strip-shaped patch B1l. The following provides descriptions with reference to FIG. 3C.

FIG. 3C is a diagram of an example of an exploded structure of the antenna element shown in FIG. 3A. Specifically, as shown in FIG. 3C, the feed network 4 may extend in a first direction, the at least one patterned patch B12 includes a first group of patches and a second group of patches that may be spaced from each other in a second direction, the second direction is set at an angle, for example, perpendicular, to the first direction, and the first group of patches and the second group of patches are located on two sides of the feed network 4. Each of the first group of patches and the second group of patches may include one or at least two patterned patches B12, and the at least two patterned patches B12 may be arranged in the first direction. In FIG. 3B, each of the first group of patches and the second group of patches includes one patterned patch B12.

In addition, the feed structure 5 may include a second feed part 52. The second feed part 52 is disposed in a first support layer 2. In other words, the second feed part 52 may be embedded in the first support layer 2. The feed network 4 can feed one end of the second feed part 52, and the other end of the second feed part 52 can feed the radiating patch 3.

The feed network 4 may feed the one end of the second feed part 52 directly or through coupling. Specifically, the one end of the second feed part 52 may be directly connected to the feed network 4; or the one end of the second feed part 52 and the feed network 4 may be spaced from each other in a thickness direction of the first support layer 2 or spaced from each other on a plane on which the feed network 4 is located, and the feed network 4 can feed the one end of the second feed part 52 through coupling. In addition, the one end of the second feed part 52 and the feed network 4 being spaced from each other in the thickness direction of the first support layer 2 means that the one end of the second feed part 52 and the feed network 4 are at different layers in the thickness direction. In this case, the one end of the second feed part 52 and the feed network 4 may be disposed in a corresponding manner or a staggered manner. The one end of the second feed part 52 and the feed network 4 being spaced from each other on the plane on which the feed network 4 is located means that the one end of the second feed part 52 and the feed network 4 are at a same layer in the thickness direction and are spaced from each other on a same plane.

The other end of the second feed part 52 may feed the radiating patch 3, that is, the first patch body B1, directly or through coupling. Specifically, the other end of the second feed part 52 is directly connected to the first patch body B1; or the other end of the second feed part 52 and the first patch body B1 may be spaced from each other in the thickness direction of the first support layer 2 or spaced from each other on a plane on which the radiating patch 3 is located, and the other end of the second feed part 52 can feed the first patch body B1 through coupling. In addition, the other end of the second feed part 52 and the first patch body B1 being spaced from each other in the thickness direction of the first support layer 2 means that the other end of the second feed part 52 and the first patch body B1, that is, the radiating patch 3, are at different layers in the thickness direction. In this case, the other end of the second feed part 52 and the radiating patch 3 may be disposed in a corresponding manner or a staggered manner. The other end of the second feed part 52 and the radiating patch 3 being spaced from each other on the plane on which the radiating patch 3 is located means that the other end of the second feed part 52 and the radiating patch 3 are at a same layer in the thickness direction and are spaced from each other on a same plane.

In FIG. 3C, the second feed part 52 of the feed structure 5 may include a main feed portion 521. In this case, one end of the main feed portion 521 may be directly connected to the feed network 4, that is, directly fed by the feed network 4, or may receive feed through coupling. The other end of the main feed portion 521 may be directly connected to the radiating patch 3, that is, directly feed the radiating patch 3, or may perform feeding through coupling. Optionally, the second feed part 52 of the feed structure 5 may further include a first coupling portion 522 and/or a second coupling portion 523 described below. The first coupling portion 522 is connected to the one end of the main feed portion 521, and the second coupling portion 523 is connected to the other end of the main feed portion 521. In this case, the one end of the main feed portion 521 may receive feed from the feed network 4 through coupling by using the first coupling portion 522, and the other end of the main feed portion 521 may feed the radiating patch 3 through coupling by using the second coupling portion 523.

FIG. 3D is a diagram of an example of a cross-sectional structure of the antenna element shown in FIG. 3A along a B-B line. As shown in FIG. 3D, the one end of the second feed part 52 is directly connected to the feed network 4, and the other end of the second feed part 52 is directly connected to the first patch body B1. In this case, the feed network 4 feeds the one end of the second feed part 52 in a direct feeding manner, and the other end of the second feed part 52 feeds the radiating patch 3 in a direct feeding manner.

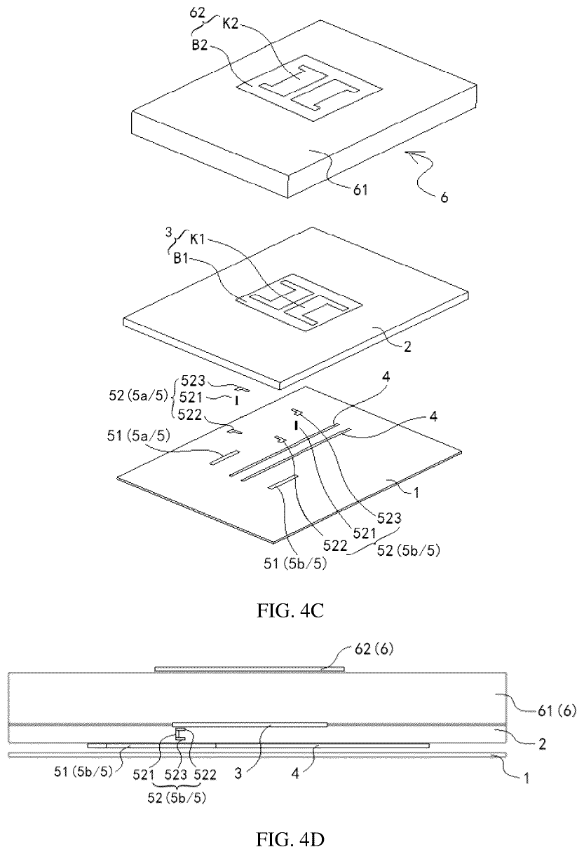

FIG. 4A is a diagram of an assembly structure of an antenna element of an antenna apparatus according to Embodiment 3 of this application. The structure of the antenna element in FIG. 4A is roughly the same as the structure of the antenna element shown in FIG. 3A. A difference from the antenna element shown in FIG. 3A lies in that, in FIG. 4A, a shape of a radiating patch 3 and a shape of a parasitic radiating patch 62 are changed, and a structure of a feed structure 5 is changed. For example, a shape of a second window K2 of the parasitic radiating patch 62 is an irregular shape similar to a “U” shape. The following provides detailed descriptions with reference to FIG. 4B, FIG. 4C, and FIG. 4D.

FIG. 4B is a diagram of a structure of a radiating patch of the antenna element shown in FIG. 4A. Based on the radiating patch shown in FIG. 3B, as shown in FIG. 4B, a first patch body B1 further includes at least one second strip-shaped patch B13. The at least one second strip-shaped patch B13 is disposed in a window region to divide the window region into at least two first windows K1. A first strip-shaped patch B11, the second strip-shaped patch B13, and a patterned patch B12 are generally integrally formed, or may be separately formed.

In addition, different second strip-shaped patches B13 may be disposed at an angle to each other, a first end of the second strip-shaped patch B13 is connected to the first strip-shaped patch B11 or the patterned patch B12, and a second end of the second strip-shaped patch B13 is connected to the first strip-shaped patch B11 or the patterned patch B12. In FIG. 4B, the first end and the second end of the second strip-shaped patch B13 are separately connected to the first strip-shaped patch B11. At least two first windows K1 may be formed by disposing the second strip-shaped patch B13 in the window region, and an area of the first window K1 is relatively small, so that flatness of the radiating patch 3 can be improved, to facilitate placement or removal of the radiating patch 3.

In addition, in another embodiment, the first strip-shaped patch B11 may not be disposed on the first patch body B1. In this case, the first patch body B1 may include at least one second strip-shaped patch B13 and at least one patterned patch B12. Different second strip-shaped patches B13 are disposed at an angle to each other, space between adjacent second strip-shaped patches B13 forms a window region, the patterned patch B12 is located in the window region and is connected to the second strip-shaped patch B13, and a region that is in the window region and in which the patterned patch B12 is not disposed forms the first window K1.

In other words, a radiating patch 3 may have but is not limited to the following several solutions:
Solution 1: A first strip-shaped patch B11, that is, an outer frame, and a second strip-shaped patch B13, that is, an inner frame, may not be disposed on a radiating patch 3, as shown in FIG. 2B, and it may be considered that a first patch body B1 is a patterned patch B12.
Solution 2: A first patch body B1 includes a first strip-shaped patch B11, that is, an outer frame, and at least one patterned patch B12, but no second strip-shaped patch B13, that is, an inner frame, is disposed, as shown in FIG. 3B.
Solution 3: A first patch body B1 includes a first strip-shaped patch B11, that is, an outer frame, at least one patterned patch B12, and at least one second strip-shaped patch B13, that is, an inner frame, as shown in FIG. 4B.
Solution 4: An outer frame, that is, a first strip-shaped patch B11, may not be disposed on a radiating patch 3, and a first patch body B1 includes at least one patterned patch B12 and at least one second strip-shaped patch B13, that is, an inner frame.

Specifically, in Solution 4, the at least one second strip-shaped patch may be used as an inner frame to form a window region, and the patterned patch B12 may be disposed in the window region. In this case, at least a part of the window region may be divided into a region in which the patterned patch B12 is disposed and a region that forms at least one first window K1. Optionally, the patterned patch B12 may not be disposed in some window regions, and in this case, the window region forms a first window K1. In an example, the first patch body B1 may include two second strip-shaped patches B13 and two patterned patches B12. In addition, the two second strip-shaped patches B13 and the two patterned patches B12 may be integrally formed. The two second strip-shaped patches B13 may be disposed at an angle to each other, for example, perpendicularly crossed, to form four window regions, that is, a first window region, a second window region, a third window region, and a fourth window region. The two patterned patches B12 may be disposed in the second window region and the third window region respectively. Each of parts that are in the second window region and the third window region and in which the patterned patch B12 is not disposed forms a first window K1, and each of the first window region and the fourth window region forms a first window K1.

FIG. 4C is a diagram of an example of an exploded structure of the antenna element shown in FIG. 4A. FIG. 4D is a diagram of an example of a cross-sectional structure of the antenna element shown in FIG. 4A along a C-C line. As shown in FIG. 4C and FIG. 4D, the feed structure 5 may include a first feed part 51 and a second feed part 52. The first feed part 51 is disposed on a side surface that is of a first support layer 2 and that faces a metal ground plane 1, and a feed network 4 can feed one end of the first feed part 51. The second feed part 52 is disposed in the first support layer 2, the other end of the first feed part 51 can feed one end of the second feed part 52, and the other end of the second feed part 52 can feed the radiating patch 3.

The one end of the second feed part 52 is directly connected to the other end of the first feed part 51; or the one end of the second feed part 52 and the first feed part 51 are spaced from each other in a thickness direction of the first support layer 2 or spaced from each other on a plane on which the first feed part 51 is located, and the other end of the first feed part 51 can feed the one end of the second feed part 52 through coupling. In other words, after the feed network 4 feeds the first feed part 51, the first feed part 51 may feed the second feed part 52 directly or through coupling. The feed network 4 may feed the first feed part 51 directly or through coupling. For details, refer to related descriptions of FIG. 2B.

In an example, when the one end of the second feed part 52 receives feed from the feed network 4 through coupling, the second feed part 52 may further include a first coupling portion 522. The first coupling portion 522 is connected to one end of a main feed portion 521. The first coupling portion 522 and the feed network 4 are spaced from each other in the thickness direction of the first support layer 2 or spaced from each other on a plane on which the feed network 4 is located. An area of a vertical projection of the first coupling portion 522 onto the plane on which the feed network 4 is located is greater than an area of a vertical projection of the one end of the main feed portion 521 onto the plane on which the feed network 4 is located. An extension direction of the first coupling portion 522 may be parallel to the plane on which the feed network 4 is located. Alternatively, the first coupling portion 522 and the feed network 4 are spaced from each other in the thickness direction of the first support layer 2, and the extension direction of the first coupling portion 522 may be inclined relative to the plane on which the feed network 4 is located. In this case, the other end of the main feed portion 521 may be directly connected to the radiating patch 3, or may feed the radiating patch 3 through coupling, or may feed the radiating patch 3 by using a second coupling portion 523 described below.

In another example, when the other end of the second feed part 52 feeds the radiating patch 3 through coupling, the second feed part 52 may further include a second coupling portion 523. The second coupling portion 523 is connected to the other end of the main feed portion 521. The second coupling portion 523 and the radiating patch 3 are spaced from each other in the thickness direction of the first support layer 2 or spaced from each other on a plane on which the radiating patch 3 is located. An area of a vertical projection of the second coupling portion 523 onto the plane on which the radiating patch 3 is located is greater than an area of a vertical projection of the other end of the main feed portion 521 onto the plane on which the radiating patch 3 is located. An extension direction of the second coupling portion 523 may be parallel to the plane on which the radiating patch 3 is located. Alternatively, the second coupling portion 523 and the radiating patch 3 are spaced from each other in the thickness direction of the first support layer 2, and the extension direction of the second coupling portion 523 may be inclined relative to the plane on which the radiating patch is located. In this case, the one end of the main feed portion 521 may be directly connected to the feed network 4, or may receive feed from the feed network 4 through coupling, or may receive feed from the feed network 4 by using the first coupling portion 522 described above.

In other words, when the second feed part 52 receives feed from the feed network 4 through coupling, if an area of a vertical projection, onto the plane on which the feed network 4 is located, of an end part that is of the main feed portion 521 of the second feed part 52 and that faces the feed network 4 is large enough to meet a coupling feed requirement, the feed network 4 may feed the main feed portion 521 through coupling. Alternatively, a first coupling portion 522 may be disposed at one end that is of the main feed portion 521 and that faces the feed network 4, to receive feed from the feed network 4 by using the first coupling portion 522. Similarly, when the second feed part 52 feeds the radiating patch 3 through coupling, if an area of a vertical projection, onto the plane on which the radiating patch 3 is located, of an end part for feeding that is of the main feed portion 521 of the second feed part 52 and that faces the radiating patch 3 is large enough to meet a coupling feed requirement, the main feed portion 521 may feed the radiating patch 3 through coupling. Alternatively, a second coupling portion 523 may be disposed at the other end that is of the main feed portion 521 and that faces the radiating patch 3, to feed the radiating patch 3 by using the second coupling portion 523.

In the antenna element of the antenna apparatus in Embodiment 1 of this application, as shown in FIG. 2B and FIG. 2C, the feed structure 5 includes a first feed part 51. In the antenna element of the antenna apparatus in Embodiment 2 of this application, as shown in FIG. 3C and FIG. 3D, the feed structure 5 includes a second feed part 52, and the second feed part 52 may include a main feed portion 521, and optionally, may further include a first coupling portion 522 and/or a second coupling portion 523. In the antenna element of the antenna apparatus in Embodiment 3 of this application, as shown in FIG. 4C and FIG. 4D, the feed structure 5 includes a first feed part 51 and a second feed part 52, and the second feed part 52 may include a main feed portion 521, and optionally, may further include a first coupling portion 522 and/or a second coupling portion 523. In addition, the feed structures 5 in the three embodiments of this application may be replaced with each other. For example, the feed structure 5 of the antenna element in Embodiment 1 may be replaced with the feed structure 5 of the antenna element in Embodiment 2 or Embodiment 3, the feed structure 5 of the antenna element in Embodiment 2 may be replaced with the feed structure 5 of the antenna element in Embodiment 1 or Embodiment 3, and the feed structure 5 of the antenna element in Embodiment 3 may be replaced with the feed structure 5 of the antenna element in Embodiment 1 or Embodiment 2.

In addition, an embodiment of this application further provides a wireless communication device. The wireless communication device may include the foregoing antenna apparatus and at least one first radio frequency circuit. At least a part of feed networks of a same antenna apparatus is connected to a same radio frequency circuit, or different feed networks 4 of a same antenna apparatus are connected to different radio frequency circuits. Specifically, the feed network 4 receives a signal transmitted by the radio frequency circuit, and may evenly divide the signal into M signal components with same energy, and provide signal components with different phases to M radiating patches 3 through M feeder lines respectively.

In an example, one antenna apparatus may include three feed networks. Two feed networks are connected to a first radio frequency circuit, a third feed network is connected to a second radio frequency circuit, and the first radio frequency circuit is different from the second radio frequency circuit. Alternatively, all feed networks of a same antenna apparatus are connected to a same radio frequency circuit. In other words, a quantity of radio frequency circuits is less than or equal to a quantity of feed networks 4.

In conclusion, for a need to increase a layout area for a feed network in an antenna array, an antenna apparatus and a wireless communication device including the antenna apparatus are provided. In the antenna apparatus, a part of feeder lines of a feed network may be located below a radiating patch, and the feed network may be further disposed in space between adjacent radiating patches, to increase a layout area for the feed network. Further, a window may be provided on the radiating patch. In this way, when the feed network and the radiating patch are arranged close to each other, mutual coupling between the feed network and the radiating patch can be reduced, to implement effect of improving isolation, array directivity, a gain, and the like. This facilitates miniaturization of the antenna apparatus.

In other words, in the antenna apparatus in embodiments of this application, in a low-profile condition, mutual coupling between an antenna such as the radiating patch and feeder lines of the feed network can be greatly reduced, that is, decoupling between the low-profile antenna and the feed network can be implemented, so that isolation between the antenna such as the radiating patch and the feed network is improved, the layout area for the feed network can be increased, element matching can be improved, and a gain and a directivity coefficient of an array antenna can be improved.

In an example, the antenna apparatus may be a ±450 dual-polarized antenna. An antenna element of the antenna apparatus may include two feed structures. In other words, there are two feed points for the radiating patch, which are located at two adjacent sides or two adjacent angles of the radiating patch respectively. The feed network is located between the radiating patch and a metal ground plane. Apart of feeder lines of the feed network is located below the radiating patch, runs through two radiation sides of the radiating patch, and is located between the two feed points. One or more feeder lines may be routed between the two feed points. A shape of an open slot/the window of the radiating patch includes but is not limited to a square, a rectangle, an arc, or the like. A manner for feeding between the feed structure and the feed network includes but is not limited to one or more of the following: coupling between upper and lower layers, that is, different-layer coupling, same-layer coupling, and a direct connection. A manner for feeding between the feed structure and the radiating patch includes but is not limited to one or more of the following: coupling between upper and lower layers, that is, different-layer coupling, same-layer coupling, and a direct connection. In addition, a second radiating patch, that is, a parasitic radiating patch, may be added on the radiating patch, to expand bandwidth.

Finally, it should be noted that the foregoing embodiments are merely intended for describing the technical solutions of this application, but not for limiting this application. Although this application is described in detail with reference to the foregoing embodiments, a person of ordinary skill in the art should understand that modifications may still be made to the technical solutions described in the foregoing embodiments or equivalent replacements may still be made to some technical features thereof, without departing from the scope of the technical solutions of embodiments of this application.

1. An antenna apparatus, comprising:
at least one antenna array having at least one antenna element, wherein the at least one antenna element comprises:
a metal ground plane configured to perform directional radiation on an electromagnetic wave signal;
a first support layer disposed on a side of the metal ground plane and spaced from the metal ground plane;
a radiating patch disposed on a side surface of the first support layer away from the metal ground plane;
at least one feed network, disposed on a side surface of the first support layer facing the metal ground plane, and spaced from the metal ground plane; and
at least one feed structure disposed on the first support layer, wherein the at least one feed structure corresponds to at least one feed network, and the at least one feed network feeds the radiating patch through the corresponding feed structure, wherein
the radiating patch comprises a first patch body and at least one first window, a vertical projection of the feed network onto a plane on which the radiating patch is located at least partially overlaps the first patch body or at least partially overlaps each of the first patch body and the at least one first window, and at least one end of the at least one feed network extends out of the radiating patch.

2. The antenna apparatus according to claim 1, wherein an area of overlap between the vertical projection of the at least one feed network onto the plane on which the radiating patch is located and the at least one first window is greater than an area of overlap between the vertical projection and the first patch body.

3. The antenna apparatus according to claim 1, wherein
the first patch body comprises a first strip-shaped patch and at least one patterned patch, the first strip-shaped patch is bent to form an internal opening, the at least one patterned patch is disposed in a first part of a region of the internal opening, and a second part of the region of the internal opening is a window region; or
the first patch body comprises at least one first strip-shaped patch and at least one patterned patch, and the at least one first strip-shaped patch and the at least one patterned patch are spliced to form a window region, wherein the at least one first window is located in the window region.

4. The antenna apparatus according to claim 3, wherein the at least one feed network extends in a first direction, the at least one patterned patch comprises a first group of patches and a second group of patches spaced from each other in a second direction, the second direction is set at an angle to the first direction, and the first group of patches and the second group of patches are located on two sides of the feed network.

5. The antenna apparatus according to claim 3, wherein the first patch body further comprises at least one second strip-shaped patch, the at least one second strip-shaped patch is disposed in the window region to divide the window region into at least two first windows, different second strip-shaped patches are disposed at an angle to each other, a first end of the second strip-shaped patch is connected to the first strip-shaped patch or the patterned patch, and a second end of the second strip-shaped patch is connected to the first strip-shaped patch or the patterned patch.

6. The antenna apparatus according to claim 1, wherein the first patch body comprises at least one second strip-shaped patch and at least one patterned patch, different second strip-shaped patches are disposed at an angle to each other, space between adjacent second strip-shaped patches forms a window region, the patterned patch is located in the window region and is connected to the second strip-shaped patch, and a region that is in the window region and in which the patterned patch is not disposed forms the first window.

7. The antenna apparatus according to claim 1, wherein
a shape of the at least one first window comprises a regular shape and/or an irregular shape, and the regular shape comprises a polygon or a circle; and
a shape of the at least one patterned patch of the first patch body comprises a regular shape and/or an irregular shape.

8. The antenna apparatus according to claim 1, wherein the at least one feed structure comprises a first feed part disposed on the side surface of the first support layer facing the metal ground plane, the at least one feed network is capable of feeding one end of the first feed part, and the other end of the first feed part corresponds to the first patch body and is configured to feed the first patch body through coupling.

9. The antenna apparatus according to claim 1, wherein the at least one feed structure comprises a second feed part disposed in the first support layer, the at least one feed network is configured to feed one end of the second feed part, and the other end of the second feed part is configured to feed the radiating patch, wherein
the one end of the second feed part is directly connected to the at least one feed network; or
the one end of the second feed part and the at least one feed network are spaced from each other in a thickness direction of the first support layer or spaced from each other on a plane on which the at least one feed network is located, and the at least one feed network is configured to feed the one end of the second feed part through coupling.

10. The antenna apparatus according to claim 1, wherein the at least one feed structure comprises:
a first feed part disposed on the side surface of the first support layer facing the metal ground plane, wherein the at least one feed network is configured to feed one end of the first feed part; and
a second feed part disposed in the first support layer, wherein the other end of the first feed part is configured to feed one end of the second feed part, and the other end of the second feed part is configured to feed the radiating patch, wherein
the one end of the second feed part is directly connected to the other end of the first feed part; or
the one end of the second feed part and the first feed part are spaced from each other in a thickness direction of the first support layer or spaced from each other on a plane on which the first feed part is located, and the other end of the first feed part is configured to feed the one end of the second feed part through coupling.

11. The antenna apparatus according to claim 8, wherein
the one end of the first feed part is directly connected to the at least one feed network; or
the one end of the first feed part is spaced from the at least one feed network, and the at least one feed network is configured to feed the one end of the first feed part through coupling.

12. The antenna apparatus according to claim 9, wherein
the other end of the second feed part is directly connected to the first patch body; or
the other end of the second feed part and the first patch body are spaced from each other in the thickness direction of the first support layer or spaced from each other on the plane on which the radiating patch is located, and the other end of the second feed part is configured to feed the first patch body through coupling.

13. The antenna apparatus according to claim 9, wherein the second feed part of the at least one feed structure comprises a main feed portion, wherein
when the one end of the second feed part receives feed from the at least one feed network through coupling, the second feed part further comprises a first coupling portion, the first coupling portion is connected to one end of the main feed portion, the first coupling portion and the at least one feed network are spaced from each other in the thickness direction of the first support layer or spaced from each other on the plane on which the at least one feed network is located, and an area of a vertical projection of the first coupling portion onto the plane on which the at least one feed network is located is greater than an area of a vertical projection of the one end of the main feed portion onto the plane on which the at least one feed network is located; and/or
when the other end of the second feed part feeds the radiating patch through coupling, the second feed part further comprises a second coupling portion, the second coupling portion is connected to the other end of the main feed portion, the second coupling portion and the radiating patch are spaced from each other in the thickness direction of the first support layer or spaced from each other on the plane on which the radiating patch is located, and an area of a vertical projection of the second coupling portion onto the plane on which the radiating patch is located is greater than an area of a vertical projection of the other end of the main feed portion onto the plane on which the radiating patch is located.

14. The antenna apparatus according to claim 1, wherein the antenna element is a dual-polarized antenna, an outer contour of the radiating patch is a rectangle, the at least one feed structure comprises a first feed structure and a second feed structure, the first feed structure and the second feed structure are located at two adjacent vertex angles or two adjacent sides of the radiating patch, respectively, the first feed structure is configured to feed an electromagnetic wave in a first polarization direction into the radiating patch, the second feed structure is configured to feed an electromagnetic wave in a second polarization direction into the radiating patch, the first polarization direction is orthogonal to the second polarization direction, and the at least one feed network is located between the first feed structure and the second feed structure.

15. The antenna apparatus according to claim 1, wherein the antenna element further comprises one parasitic radiating component or at least two stacked parasitic radiating components, and the one parasitic radiating component, or the at least two stacked parasitic radiating components comprises:
a second support layer disposed on a side surface of the radiating patch and away from the first support layer; and
one or more parasitic radiating patches disposed on a side surface of the second support layer away from the radiating patch, and at least partially overlapping the radiating patch.

16. The antenna apparatus according to claim 15, wherein the one or more parasitic radiating patches comprises at least one second window and a second patch body, and a vertical projection of the at least one feed network onto a plane on which the parasitic radiating patch is located partially or completely overlaps at least one of the second window and the second patch body; and
a shape of the second window is the same as or different from a shape of the first window, and a structure of the second patch body is the same as or different from a structure of the first patch body.

17. The antenna apparatus according to claim 15, wherein a material of the second support layer is the same as or different from a material of the first support layer.

18. The antenna apparatus according to claim 1, wherein the material of the first support layer comprises at least one of: ceramic, plastic, or foam.

19. The antenna apparatus according to claim 1, further comprising:
a plurality of antenna elements, wherein the plurality of antenna elements are arranged in an array according to a specified shape, and feed networks of the plurality of antenna elements are connected; or the plurality of antenna elements are divided into a plurality of groups, and feed networks of each group of antenna elements are connected, wherein
metal ground planes of the plurality of antenna elements are integrally formed or separately formed;
first support layers of the plurality of antenna elements are integrally formed or separately formed; and
second support layers of the plurality of antenna elements are integrally formed or separately formed.

20. A wireless communication device, comprising:
at least one antenna apparatus having at least one antenna array, wherein the antenna array comprises at least one antenna element, and the at least one antenna element comprises:
a metal ground plane configured to perform directional radiation on an electromagnetic wave signal;
a first support layer disposed on a side of the metal ground plane and spaced from the metal ground plane;
a radiating patch disposed on a side surface of the first support layer away from the metal ground plane;
at least one feed network, disposed on a side surface of the first support layer facing the metal ground plane, and spaced from the metal ground plane; and
at least one feed structure disposed on the first support layer, wherein the at least one feed structure corresponds to the at least one feed network, and the at least one feed network feeds the radiating patch through the corresponding at least one feed structure, wherein
the radiating patch comprises a first patch body and at least one first window, a vertical projection of the at least one feed network onto a plane on which the radiating patch is located at least partially overlaps the first patch body or at least partially overlaps each of the first patch body and the at least one first window, and at least one end of the at least one feed network extends out of the radiating patch; and
at least one radio frequency circuit, wherein at least a part of feed networks of a same antenna apparatus is connected to a same radio frequency circuit, or different feed networks of a same antenna apparatus are connected to different radio frequency circuits.
